(19) United States
(12) Patent Application Publication
(10) Pub. No.: US 2008/0028909 A1
(43) Pub. Date: Feb. 7, 2008

(54) Adjustable ruler of the band saw machine

(75) Inventor: Jung-Hua Lin, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Yung Li Hsing Electric Works Co., Ltd., Hsien (TW)

(21) Appl. No.: 11/497,249

(22) Filed: Aug. 2, 2006

(51) Int. Cl. B23D 55/08

(52) U.S. Cl. 83/820

(57) ABSTRACT

An adjustable ruler of the band saw machine includes: a ruler-guider plugs in the band saw machine over the bench and a mesh portion along the long axis on one side of the ruler-guider. There is a holder on the extending end of the ruler-guider. An active wheel pivots in the band saw machine and gears with the mesh portion of the ruler-guider. An axis plugs on the band saw machine. One end of the axis extends out of the band saw machine and another end combines with the active wheel. A knob with scales around the surface mounts on the extending end of the axis.

### BACKGROUND OF THE INVENTION

1. Field of the Invention

The present invention relates to a band saw machine and more particularly to an adjustable ruler of the band saw machine.

2. Description of the Related Art

In order to measure the thickness of a workpiece and prevent the band saw break down from over vibration, there is an extendable ruler mounted over the bench of the band saw machine in general. The ruler is a ruler-guider with a scale thereon plugs in the band saw machine over the bench and parallel with the moving direction of the band saw. The ruler can move forward out or backward into the band saw machine to change the height away from the bench and measure the thickness of an object by the way and protect the band saw also. Because of the scale sets on the surface of the rule-guider and the height calculates from the shortage of the ruler-guider, the band saw machine usually shelters the scale from the sight of an operator. The operator needs to band down for checking the scale. This makes the structures very inconvenience in operation.

### SUMMARY OF THE INVENTION

The object of the present invention is to provide an adjustable ruler of the band saw machine with simple and easy components and high accuracy.

To achieve this object of the present invention, an adjustable ruler of the band saw machine includes: A ruler-guider plugs in the band saw machine over the bench. There is a mesh portion on one side of the ruler-guider. There is a holder on the extending end of the ruler-guider. An active wheel pivots in the band saw machine and gears with the mesh portion of the ruler-guider. An axis plugs on the band saw machine. One end of the axis extends out of the band saw machine and another end combines with the active wheel. A knob with scales around the surface mounts on the extending end of the axis.

### BRIEF DESCRIPTION OF THE DRAWINGS

FIG. 1 is a perspective view of the present invention;

FIG. 2 is a front view of the present invention;

FIG. 3 is a side view of present invention;

### DETAILED DESCRIPTION OF THE INVENTION

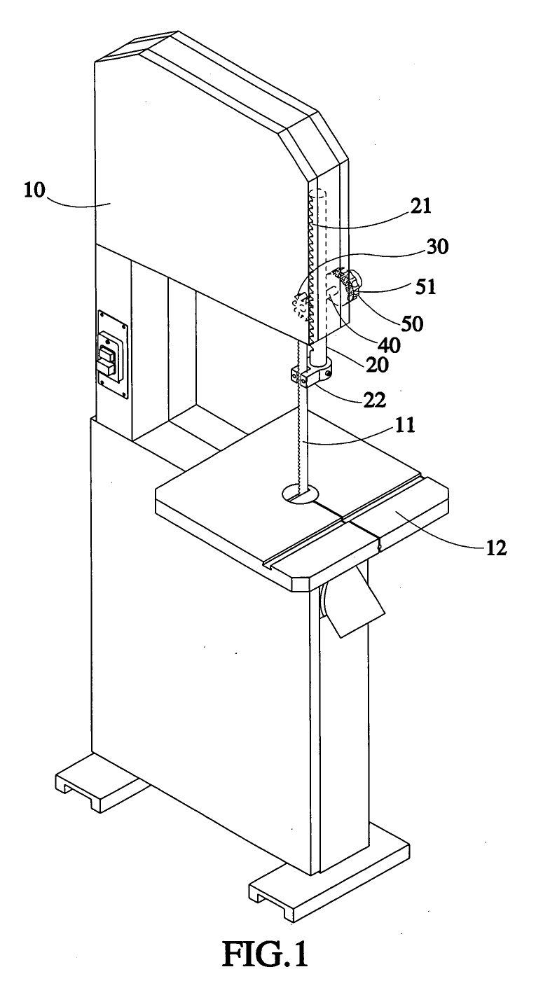

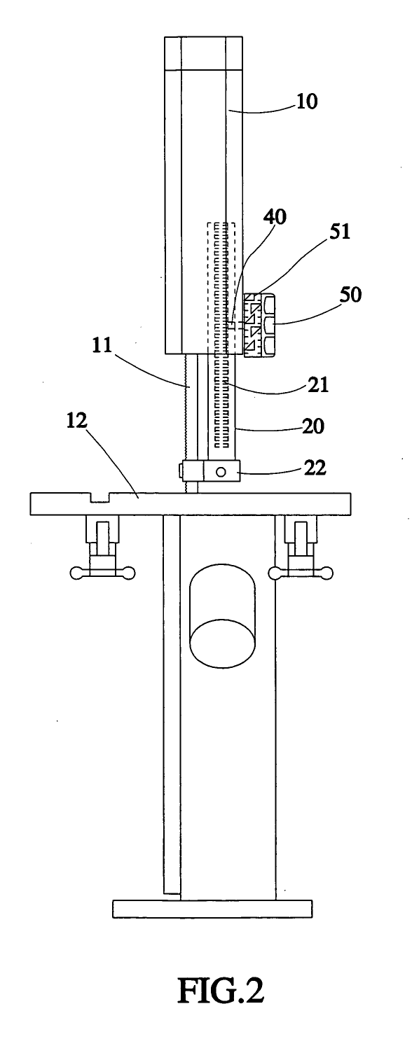

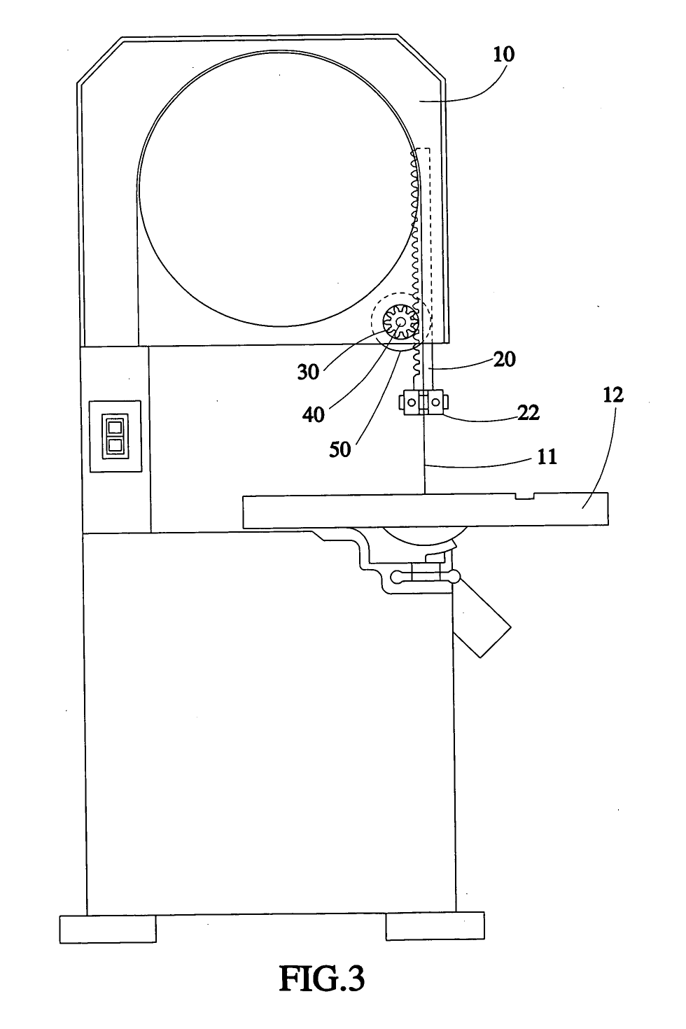

Referring to FIG. 1 to FIG. 3, an adjustable ruler of the band saw machine of present invention that mounts over a bench of a band saw machine 10 includes:

A ruler-guider 20 plugs in the band saw machine 10 over the bench 12 and parallel with the moving direction of the band saw 11. There is a mesh portion 21 along the long axis on one side of the ruler-guider. The ruler-guider can be a gear row or a worm. There is a holder 22 on the extending end of the ruler-guider to reduce the vibration of the band saw.

An active wheel 30 pivots in the band saw machine and gears with the mesh portion 21 of the ruler-guider. Depending on the ruler-guider, the active wheel can be a gear or a worm gear.

An axis 40 plugs on the band saw machine 10. One end of the axis extends out of the band saw machine and another end combines with the active wheel 30.

A knob 50 with scales 51 around the surface mounts on the extending end of the axis 40.

According to aforesaid structures, the active wheel 30 can rotate and move the ruler-guider 20 up or down when the knob 50 is rotated by the operator. Meanwhile, the scales around the surface of the knob will change when the knob is rotated. The operator can read the scale on the knob easily and clearly when the scales match up the pointer that sets on the band saw machine. By the way, the scale will not be sheltered anymore and the operator can check the scale directly and easily without bend down his body. The structures of present invention really improve those disadvantages of prior art and increase the operation efficiency.

What is claimed is:

1. An adjustable ruler of the band saw machine, comprising:
a ruler-guider plugs in the band saw machine over the bench; there is a mesh portion on one side of the ruler-guider; there is a holder on the extending end of the ruler-guider;
an active wheel pivots in the band saw machine and gears with the mesh portion of the ruler-guider;
an axis plugs on the band saw machine; one end of the axis extends out of the band saw machine and another end combines with the active wheel.
a knob with scales around the surface mounts on the extending end of the axis.

2. The adjustable ruler as claimed in claim 1, wherein the ruler-guider plugs in the band saw machine over the bench and parallel with the moving direction of the band saw.

3. The adjustable ruler as claimed in claim 1, wherein the mesh portion sets along the long axis on a side of the ruler-guider.
